(19) United States
(12) Patent Application Publication
(10) Pub. No.: US 2012/0039268 A1
(43) Pub. Date: Feb. 16, 2012

(54) Apparatus for Controlling Spectrum Exploitation Utilising Overlapping Channel Bandwidths

(76) Inventors: Hannu Tapio Häkkinen, Espoo (FI); Sabine Rössel, Munich (DE)

(21) Appl. No.: 13/148,415

(22) PCT Filed: Feb. 9, 2009
(86) PCT No.: PCT/EP2009/051464

§ 371 Date: Oct. 31, 2011

(51) Int. Cl. H04W 72/04

(52) U.S. Cl. 370/329

(57) ABSTRACT

An apparatus for controlling spectrum exploitation utilising overlapping channel bandwidths comprises a carrier utilization element configured to utilize a combination of pre-configured channel bandwidths for wireless communication within an available frequency spectrum, wherein the combination includes overlapping pre-configured channel bandwidths.

### FIELD OF THE INVENTION

The present invention generally relates to wireless communication. In particular, the present invention relates to apparatuses, methods and computer programs operating in wireless communication systems and/or controlling wireless communication systems as well as to systems comprising such apparatuses and computer programs which may be operated and/or controlled by such methods and computer programs.

Specifically, non-limiting embodiments of the present invention relate to the LTE/E-UTRAN Downlink and Uplink air interface and its evolution towards further releases (i.e. LTE-Advanced) and may be applied to any other OFDM or any other transmission technology.

### RELATED BACKGROUND ART

For the description set forth hereinafter, the following abbreviations are defined:

3GPP 3^{rd} Generation Partnership Project

ARQ Automatic Repeat Request

DL Downlink

eNB evolved Node B

E-UTRAN Evolved UTRAN system

ICIC Inter-Cell Interference Coordination

LTE Long Term Evolution of UTRAN system

LTE Rel-8 LTE release 8

OFDM Orthogonal Frequency Division Multiplex

PBCH Physical Broadcast Channel

PCFICH Physical Format Indicator Channel

PDCCH Physical Downlink Control Channel

PDSCH Physical Downlink Shared Channel

PHICH Physical Hybrid ARQ Indicator Channel

PMCH Physical Multicast Channel

PRACH Physical Random Access Channel

PUCCH Physical Uplink Control Channel

PUSCH Physical Uplink Shared Channel

RRC Radio Resource Control

SC sub-carrier

TTI Transmission Time Interval

UE User Equipment

UL Uplink

UMTS Universal Mobile Telecommunications System

UTRAN UMTS Terrestrial Radio Access Network

Related prior art can be found e.g. in the technical specifications of the 3GPP, namely documents TS 36.101 (v8.4.0), TS 36.104 (v8.4.0), TS 36.211 (v8.5.0), TS 36.212 (v8.5.0), TS 36.213 (v8.5.0), and TS 36.331 (v8.4.0), all related to release 8 and hereinafter referred to in the form of “TS 36.101”, etc.

According to this prior art, the LTE/E-UTRAN Downlink air interface (see TS 36.211, TS 36.212, and TS 36.213) is based on Orthogonal Frequency Division Multiple Access comprising the following data channels: Physical Downlink Shared Channel (PDSCH) and Physical Multicast Channel (PMCH), as well as on the following control channels: Physical Downlink Control Channel (PDCCH), Physical Control Format Indicator Channel (PCFICH), Physical Hybrid Indicator Channel (PHICH), Physical Broadcast Channel (PBCH), and Primary and secondary synchronization channel (SCH).

FIG. 1 shows a TTI (LTE sub-frame) containing the primary and secondary synchronization channels (SCH) as well as the PBCH with the 1^{st} OFDM symbol for PDCCH, PCFICH, and PHICH, i.e. the allocation in the 1^{st} OFDM symbol.

For LTE Rel-8 system bandwidths larger than 1.4 MHz, 1, 2, or 3 OFDM symbols per TTI can be configured for the PDCCH channel. The number of PDDCH OFDM symbols depends on the traffic model, i.e. on the amount of user equipment scheduled (both in Downlink and in Uplink) in the corresponding TTI.

The LTE/E-UTRAN Uplink air interface (see TS 36.211, TS 36.212, and TS 36.213) is based on Single Carrier Frequency Division Multiple Access (SC-FDMA) comprising the following shared channel: Physical Uplink Shared Channel (PUSCH) and the following physical control channels: Physical Uplink Control Channel (PUCCH) and the Physical Random Access Channel (PRACH).

At present, the PUCCH resource pool can be configured symmetrically with respect to the carrier center at the lower and upper carrier edges. The PUCCH is hopping with a hopping frequency of TTI (=1 time slot).

The mapping of logical resource blocks (denoted as m) into physical resource blocks is shown in FIG. 2. It is to be noted that slot based frequency hopping is always used on PUCCH. The following denotations apply:
n_{PRB} Physical resource block number (index)
N_{RB}^{UL} Uplink bandwidth configuration, expressed in multiples of (N_{sc}^{RB}=12)

Currently, an asymmetric (with respect to the carrier center) PUCCH resource pool configuration is discussed in 3GPP.

The PRACH channel can be configured anywhere in the Uplink spectrum. The following further denotations apply:
n_{PRB}^{RA} First physical resource block occupied by PRACH resource considered
n_{PRB offset}^{RA} First physical resource block available for PRACH

The first physical resource block n_{PRB}^{RA} allocated to the PRACH opportunity is defined as n_{PRB}^{RA}=n_{PRB offset}^{RA}, where the PRACH frequency offset n_{PRB offset}^{RA} is expressed as a physical resource block number configured by higher layers and fulfilling 0≦n_{PRBoffset}^{RA}≦N_{RB}^{UL}−6.

The resource mapping of the physical Downlink and Uplink channels relates to the Downlink N_DL_RB and Uplink system bandwidth N_UL_RB which are configuration parameters in the TS 36.21x specifications and which represent the available number of Downlink or Uplink Resource Blocks (RBs).

While the PBCH and the Primary and Secondary SCH are centered with respect to the DL carrier using a narrow bandwidth of 6 Resource Blocks (RBs), the PDCCH, the PCFICH and the PHICH extend over the complete Downlink system bandwidth as configured by N_DL_RB. The PDSCH and the PMCH allocations are controlled by scheduling. Further limitation of PDSCH and PMCH bandwidth beyond the configuration limit N_DL_RB depends on the DL scheduler and is LTE Rel-8 compliant.

Further limitation, however, of the PDCCH, PCFICH, and PHICH beyond the configured Downlink system bandwidth is not possible in general and may require an optimized control channel DL scheduler.

While the PRACH can be configured anywhere, and the PUSCH can be limited in bandwidth beyond the configuration limits set by N_UL_RB, the PUCCH resource pool exactly exploits the configured N_UL_RB.

Hence, further limitation of UL bandwidth beyond the configured Uplink system bandwidth is not possible in general or may require an optimized control channel UL scheduler.

The LTE system bandwidths could be flexibly configured if all options for N_DL_RB and N_UL_RB ranging from 6 RBs up to 110 RBs are supported.

However, following TS 36.104 and TS 36.101 only selected LTE system bandwidths N_RB are supported by the standard Rel-8: For frequency division duplexing (FDD) these are 1.4 MHz, 3 MHz, 5 MHz, 10 MHz, 15 MHz and 20 MHz. The standardized system bandwidths are given e.g. in Table 5.6-1 of version 8.4.0 of TS 36.104 (analogous in TS 36.101) which is shown in FIG. 3 (transmission bandwidth table). That is, FIG. 3 shows the channel bandwidth BW_{channel} as a frequency in [MHz] in relation to the transmission bandwidth configuration N_{RB} which is the highest transmission bandwidth allowed for uplink or downlink in a given channel bandwidth, measured in resource block (RB) units.

The RRC layer sets the Downlink and Uplink system bandwidths in the Master and System Information Blocks as specified in TS 36.331. The supported bandwidths (for Downlink and Uplink independent values) correspond to the ones listed in Table 5.6-1 of TS 36.104 shown in FIG. 3. The parameter has nine spare values for potentially new system bandwidth configurations.

In accordance to the aforementioned, in LTE Rel-8 a deviation from the configured Downlink and Uplink system bandwidths is not possible in general.

Hence, the strict limitation of LTE Downlink and Uplink system bandwidths leads to limitations in spectrum exploitation.

Specifically, operators having spectrum blocks not matching the configurable system bandwidths cannot fully exploit their spectrum. They should use the next smaller system bandwidth (e.g. 5 MHz in a 9 MHz frequency block) or retreat to a multi-carrier LTE system where a set of smaller bandwidths is used to exploit the operator's spectrum.

In future LTE releases (e.g. LTE-Advanced), carrier aggregation will be a key feature. However, with the limited set of LTE Release 8 bandwidths also the contiguous or non-contiguous aggregation of the carriers will suffer from limitations for spectrum exploitation.

Operators having spectrum blocks not matching the configurable system bandwidths may thus combine multiple smaller carriers for a multi-carrier LTE network (e.g. 5+3 MHz in a 9 MHz frequency block), or squeeze a 10 MHz system bandwidth into 9 MHz.

The former solution does not fully exploit the available spectrum, while the latter solution can only be used if the deviation from the configurable DL system bandwidth is not too large and if the coexistence situation allows for using standard terminals (e.g. in this case at 10 MHz).

### SUMMARY OF THE INVENTION

In the light of the above, it is an object of the present invention to overcome the shortcomings of the prior art.

According to a first aspect of the present invention there is provided an apparatus, comprising a carrier utilization element configured to utilize a combination of pre-configured channel bandwidths for wireless communication within an available frequency spectrum, wherein the combination includes overlapping pre-configured channel bandwidths.

The first aspect of the present invention may be modified as follows.

The apparatus may be suitable for optimizing spectrum exploitation.

Carriers corresponding to the overlapping pre-configured channel bandwidths may comprise a time offset.

The apparatus may further comprise a downlink scheduler element configured to avoid allocation of a downlink data channel in a region of overlapping pre-configured channel bandwidths.

Outer guard bands for the available frequency spectrum in which no channels are to be allocated may be provided by virtual guard bands of the pre-configured channel bandwidths.

The downlink scheduler element may be further configured to send cell-specific downlink reference symbols of both of the carriers corresponding to pair-wise overlapping pre-configured channel bandwidths in the region of overlapping pre-configured channel bandwidths.

The apparatus may be configured as a user equipment component and the carrier utilization element may be further configured to utilize the overlapping pre-configured channel bandwidths at the same time.

The apparatus may be configured as a base station and the carrier utilization element may be further configured to schedule the overlapping pre-configured channel bandwidths for use at the same time.

According a second aspect of the present invention, there is provided a method, comprising utilizing a combination of pre-configured channel bandwidths for wireless communication by a carrier utilization element within an available frequency spectrum, wherein the combination includes overlapping pre-configured channel bandwidths.

The second aspect of the present invention may be modified as follows.

The method may be suitable for optimizing spectrum exploitation.

Carriers corresponding to the overlapping pre-configured channel bandwidths may comprise a time offset.

The method may further comprise avoiding allocation of a downlink data channel in a region of overlapping pre-configured channel bandwidths by a downlink scheduler element.

Outer guard bands for the available frequency spectrum in which no channels are to be allocated may be provided by virtual guard bands of the pre-configured channel bandwidths.

The method may further comprise sending cell-specific downlink reference symbols of both of the carriers corresponding to pair-wise overlapping pre-configured channel bandwidths in the region of overlapping pre-configured channel bandwidths by the downlink scheduler element.

The method may further comprise utilizing the overlapping pre-configured channel bandwidths at the same time by a user equipment component.

The method may further comprise scheduling the overlapping pre-configured channel bandwidths for use at the same time by a base station.

According to a third aspect of the present invention, there is provided a computer program product embodied on a computer-readable medium encoded with instructions that, when executed on a computer, perform utilizing a combination of pre-configured channel bandwidths for wireless communication by a carrier utilization element within an available frequency spectrum, wherein the combination includes overlapping pre-configured channel bandwidths.

The third aspect of the present invention may be modified in a manner corresponding to the modifications of the second aspect.

According to a fourth aspect of the present invention, there is provided a system, comprising one or more power amplifier configured to provide at least two carrier having overlapping channel bandwidths; and a cellular wireless communication network controller configured to provide an air interface communication protocol over a range covered by the overlapping channel bandwidth.

The fourth aspect of the present invention may be modified as follows.

The system may be suitable for optimizing spectrum exploitation.

The system may further comprise a deployment element configured to deploy one of a set of combinations of pre-configured channel bandwidths, in which for each combination the carrier center frequency of each pre-configured channel bandwidth comprises the same distance to a lower edge of an available frequency spectrum, for a specific cell of the cellular network, and to deploy another one of the set of combinations for a cell neighboring to said specific cell.

According to a fifth aspect of the present invention, there is provided an apparatus, comprising a means for utilizing a combination of pre-configured channel bandwidths for wireless communication within an available frequency spectrum, wherein the combination includes overlapping pre-configured channel bandwidths.

The fifth aspect of the present invention may be modified in a manner corresponding to the modifications of the first aspect.

According to a sixth aspect of the present invention, there is provided a system, comprising one or more power amplifier means for providing at least two carrier having overlapping channel bandwidths; and a cellular wireless communication network controlling means for providing an air interface communication protocol over a range covered by the overlapping channel bandwidth.

The sixth aspect of the present invention may be modified in a manner corresponding to the modifications of the fourth aspect.

According to a seventh aspect of the present invention, there is provided a method, providing at least two carriers having overlapping channel bandwidths by one or more power amplifier; and providing an air interface communication protocol over a range covered by the overlapping channel bandwidth by a cellular wireless communication network controller.

The seventh aspect of the present invention may be modified as follows.

The method may be suitable for optimizing spectrum exploitation.

The method may further comprise deploying one of a set of combinations of pre-configured channel bandwidths by a deployment element, in which for each combination the carrier center frequency of each pre-configured channel bandwidth comprises the same distance to a lower edge of an available frequency spectrum, for a specific cell of the cellular network, and deploying another one of the set of combinations for a cell neighboring to said specific cell by said deployment element.

### BRIEF DESCRIPTION OF THE DRAWINGS

Other objects, features and advantages of the present invention will become apparent from the following detailed description of the embodiments of the present invention which is to be taken in conjunction with the drawings, in which:

FIG. 1 shows an exemplary allocation in a 1^{st} OFDM symbol in an LTE sub-frame (PDCCH, PCFICH, and PHICH) according to the prior art;

FIG. 2 shows the current mapping to physical resource blocks for PUCCH according to the prior art specification TS 36.211;

FIG. 3 shows the transmission bandwidth table as disclosed by the prior art specification TS 36.104;

FIG. 4 shows overlapped carriers of 5 MHz bandwidth with a center frequency distance of 3.9 MHz in order to cover less than but closest possible to 9 MHz spectrum (DL view) as an example illustrating the present invention;

FIG. 5a shows varying Frequency Reuse >1 schemes for frequency blocks not matching LTE Rel-8 bandwidths according to an embodiment of the present invention; and

FIG. 5b shows varying Frequency Reuse >1 schemes for frequency blocks not matching LTE Rel-8 bandwidths according to another embodiment of the present invention.

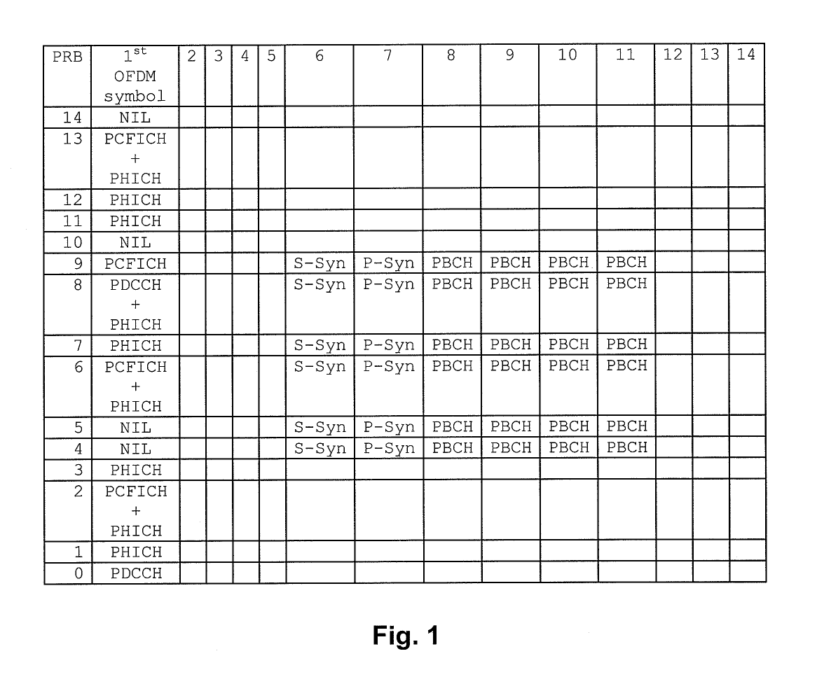

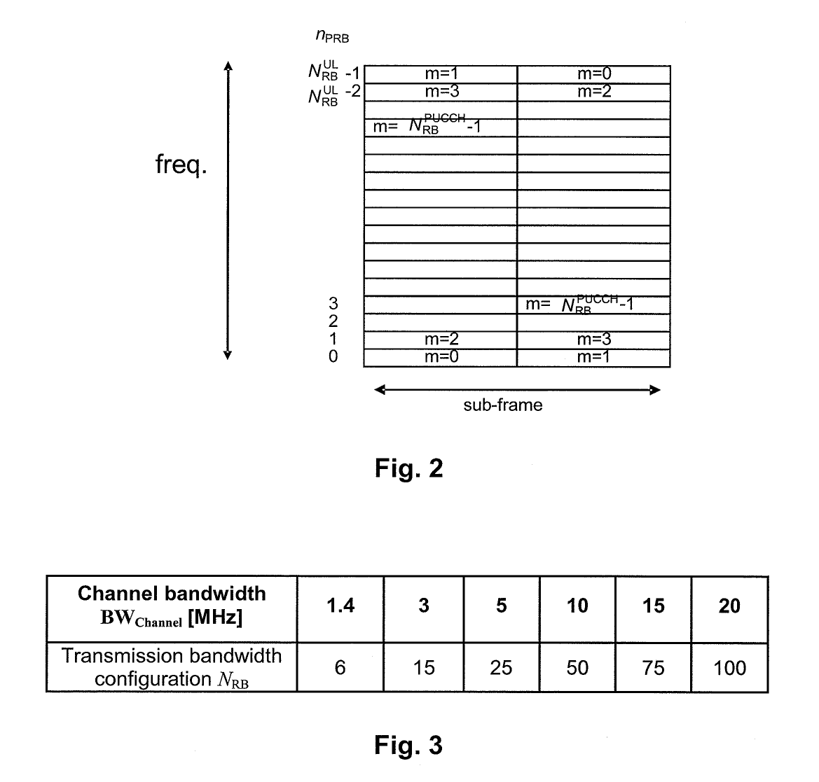

### DETAILED DESCRIPTION OF THE PRESENT EMBODIMENTS

In the following, description will be made to what are presently considered to be preferred embodiments of the present invention. It is to be understood, however, that the description is given by way of example only, and that the described embodiments are by no means to be understood as limiting the present invention thereto.

For example, for illustration purposes, in the following exemplary embodiments are described inter alia with respect to LTE/E-UTRAN. However, it should be appreciated that these exemplary embodiments are not limited for use among this particular type of wireless communication systems, and according to further exemplary embodiments, the present invention can be applied to other communication systems where it is possible that the configurable system bandwidths do not match the frequency spectrum block for operation. Thus, it should be apparent that still further exemplary embodiments are related to optimized spectrum exploitation in other communication systems.

According to certain embodiments of the present invention, a given frequency spectrum block for operation is exploited in a more optimized way by a combination of multiple overlapped carriers which overlap with respect to the configurable standard system bandwidth both for LTE Release 8 as well as for future LTE releases (e.g. LTE-Advanced) and which increase the possibilities to enhance Inter-Cell Interference Coordination (ICIC) schemes as an example for network optimization.

For example, for LTE Rel-8, two of the 5 MHz configured system bandwidths can be used in overlapped fashion for a 9 or 9.2 MHz spectrum (typical GSM re-framing remainder).

Further, for LTE-Advanced, e.g. a 20 or (2×10) MHz configured system bandwidth plus a 10 MHz configured system bandwidth can be used in overlapped fashion for a 28 MHz spectrum to be LTE Rel-8 backward compliant (4×7 MHz blocks in WiMAX band).

Accordingly, the overlapped carriers may be
Applied compliant to LTE Rel-8,
Used backward-compliant in future LTE releases supporting LTE Rel-8 UEs and eNBs,
Used analogously in LTE-Advanced when aggregating LTE Rel-8 carriers in an overlapped manner, and
Applied to other OFDM-based technologies, as well as to further structured transmission technologies based on aggregations of smaller narrowband channels.

Overlapped carriers can be exploited to enhance the degrees of freedom for network optimization for example for Inter-Cell Interference Coordination (ICIC).

Referring e.g. to the above example based on a 9 MHz frequency block, an operator may deploy a Frequency Reuse >1 scheme for Inter-Cell Interference Coordination which consists of the following three cell deployment variants:
1) 5 MHz (with carrier center at 2.5 MHz)+3 MHz with carrier center at 4 MHz from lower edge of frequency block; uncovered are 1 MHz at upper end of frequency block.
2) 3 MHz (with carrier center at 2.5 MHz)+5 MHz with carrier center at 4 MHz from lower edge of frequency block; uncovered are 1 MHz at lower end of frequency block.
3) 5 MHz (with carrier center at 2.5 MHz)+5 MHz with carrier center at 4 MHz from lower edge of frequency block; uncovered (at least with respect to the shared channel PDSCH) is the overlap region between the two 5 MHz carriers.

This is a set of multi-carrier schemes which maintains the carrier center positions (enabling intra-frequency handover for ease of implementation as well as handover optimization) and leaves varying parts of the shared channel unallocated such that an ICIC scheme can be applied.

In the following, certain embodiments of the present invention are described in greater detail in order to illustrate the obtainable advantages and technical possibilities even further.

As indicated above, according to certain embodiments of the present invention the overlapped carriers can be used for optimum spectrum exploitation. This is described hereinafter in further detail.

The concept of overlapped carriers for LTE Rel-8 and backward-compliant with LTE Rel-8 can comprise the following.

The eNB is synchronized to the level of OFDM symbols with a synchronization spread significantly less than the propagation delay spread.

Two or more carriers may be transmitted from a single power amplifier or multiple power amplifiers as follows: The center frequencies of these carriers and the standard configurable bandwidth of these carriers are defined in such a way that the overall bandwidth covered by the combined multiple carriers matches the spectrum bandwidth available to the operator. In the example used so far, this corresponds in allocating two 5 MHz carriers with a 3.9 MHz distance between the center frequencies to cover close to 9 MHz.

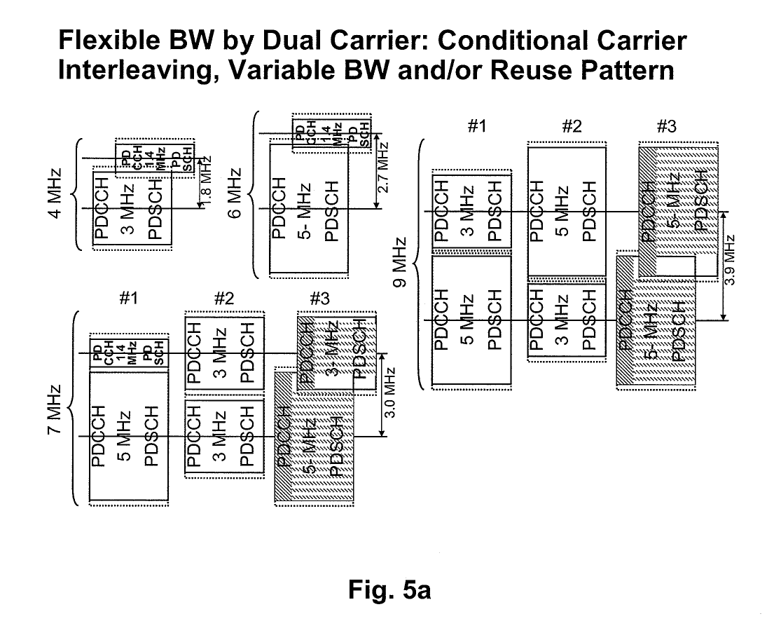

This is illustrated in FIG. 4 showing overlapped carriers of 5 MHz bandwidth with a center frequency distance of 3.9 MHz in order to cover less than but closest possible to a 9 MHz spectrum (DL view).

Specifically, according to certain embodiments of the present invention, the following Downlink coordination steps can be applied in case of overlapped carriers:
PBCH, Primary and Secondary Synch: The center frequency distances of overlapped carriers are selected to be large enough to avoid resource mapping conflicts with respect to PBCH, Primary and Secondary Synch.
PDCCH (and PCFICH, PHICH): As the PDCCH (and PCFICH, PHICH) for the UE extends over the full configured bandwidth (i.e. 5 MHz) for both or all overlapped carriers, interference on control channel OFDM symbols can be avoided by a defined offset.
PDSCH: The DL scheduler does not allocate in the overlap region to avoid Common Reference Signal conflicts with the data.
Outer (virtual) guard bands: For the dimensioning of the overlapped carrier system, it is sufficient to provision outer (virtual) guard bands related to the individual carrier bandwidths. In the example, the virtual guard band of 2×250 kHz for 5 MHz carriers is established as outer guard band.
Cell-specific Downlink reference symbols: Cell-specific Downlink reference symbols are calculated in both cases just as if the carriers do not overlap. In the overlapped case, the cell-specific Downlink reference symbols of both carriers are sent in the overlap area. Collision of the two reference symbol patterns can be avoided with suitable configuration of physical layer parameters. Further, need for puncturing of PDCCH symbols can be avoided or minimized depending on the number of OFDM symbols allocated for PDCCH and on the number of antenna ports. An example case: two antenna ports and three OFDM symbols for PDCCH. The sub-frames of the two carriers should be time offset by six OFDMA symbols. In this case, one PDCCH would not be punctured at all and another PDCCH must be punctured within a single OFDM symbol. Some puncturing may be tolerable due to robust encoding and techniques for proper de-population of PDCCH physical resource blocks. In the frequency domain, i.e. in terms of sub-carriers, mapping of reference symbols can be controlled by the selection of the two Cell IDs. For further details, reference is made to chapter 6.10.1.2 of 3GPP TS 36.211 v8.4.0.

Uplink interference coordination for overlapped carriers exploits a PUCCH blanking technique. Based on LTE release 8, PUCCH Blanking refers the following: The PUCCH resource pool in multiples of Physical Resource Blocks (PRBs) is overdimensioned first, then outer PRBs of the PUCCH resource pool are not used for PUCCH allocation.

Finally, depending on the available UL bandwidth, the UL scheduler may allocate the PUSCH channel onto unused PUCCH resources.

In contrast to the Downlink, in Uplink the overlap area is allocated to one of the overlapping carriers.

According to certain embodiments of the present invention, considerable resource gains from are obtained by the LTE Rel-8 overlapped carrier deployment.

In order to illustrate the potential of overlapped carrier deployment, in the following table resource gains for an overlapped carrier deployment are compared to a conservative multiple carrier deployment with (one) smaller bandwidth(s).

TABLE 1
Resource gains for an overlapped carrier deployment

| | | Delta | | | Delta | |
|---|---|---|---|---|---|---|
| | | vs. | Peak | | vs. | Peak |
| 9 MHz | Available | 5 + 3 | DL | Available | 5 + 3 | UL |
| Solution | DL RBs | MHz | RBs | UL RBs | MHz | RBs |
| Conservative: | 25 + 15 = | 0% | 25 | 25 + 15 = | +0% | 20 |
| 5 + 3 MHz | 40 | | | 40 | | |
| Overlapped 5 + | 2 × (25 − | +10% | 25 | (25 − 3) + | +17.5% | 20 |
| 5 MHz | 3) = 44 | | | 25 = 47 | | |

As mentioned above, according to certain embodiments of the present invention an ICIC network optimization is enabled by exploiting the overlapped carrier deployment. This is described hereinafter in further detail.

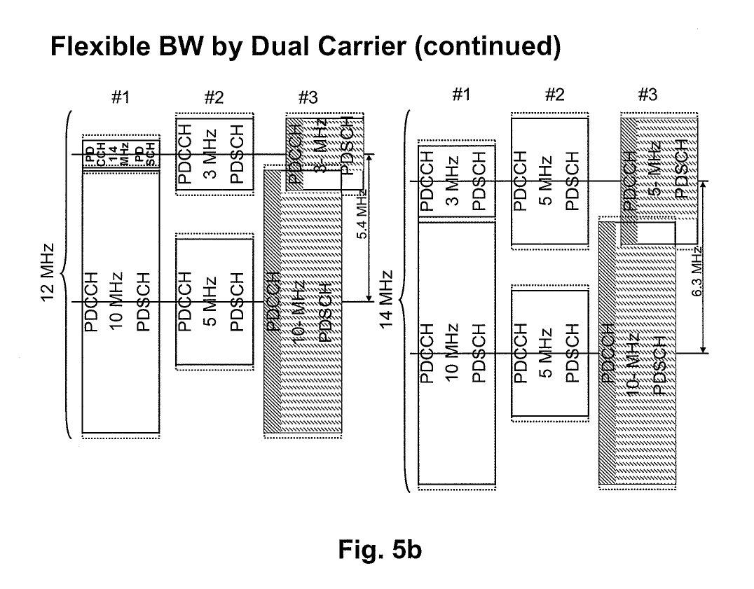

FIGS. 5a and 5b illustrate for various frequency blocks not matching the LTE Rel-8 bandwidths potential dual-carrier deployments that allow for Inter-Cell Interference Coordination.

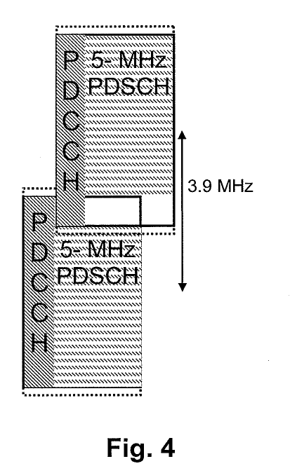

In those deployment variations using overlapped carriers, the non-allocation of the downlink channels in the overlapped area and the allocation of the uplink channels in the overlapped area are indicated by hatching in the same manner as in FIG. 3. The hatchings are omitted from the other variations in order to increase the intelligibility.

As explained above for the example based on a 9 MHz frequency block, an operator may deploy a Frequency Reuse >1 scheme for Inter-Cell Interference Coordination which consists of the following three cell deployment variants:
1) 5 MHz (with carrier center at 2.5 MHz)+3 MHz with carrier center at 4 MHz from lower edge of frequency block; uncovered are 1 MHz at upper end of frequency block.
2) 3 MHz (with carrier center at 2.5 MHz)+5 MHz with carrier center at 4 MHz from lower edge of frequency block; uncovered are 1 MHz at lower end of frequency block.
3) 5 MHz (with carrier center at 2.5 MHz)+5 MHz with carrier center at 4 MHz from lower edge of frequency block; uncovered (at least with respect to the shared channel PDSCH) is the overlap region between the two 5 MHz carriers.

This is an example for a dual-carrier scheme based on overlapped carriers which maintains the carrier center positions (enabling intra-frequency handover for ease of implementation as well as handover optimization) and leaves varying parts of the frequency block unallocated such that a static ICIC scheme can be applied.

Those embodiments of the present invention which include the dual-carrier ICIC scenarios based on overlapped carriers comprise the following advantages:
By maintaining the carrier center positions, intra-frequency handover is possible on both carriers. (In addition, blind inter-frequency handover within a sector may be applied for load balancing.)
Variable bandwidths on a per cell basis can be combined with ICIC schemes.
Orthogonality with respect to sub-carriers (i.e. 15 kHz spacing) over both carriers can be maintained: n×300 kHz carrier spacing.
Reuse of 1 or 3/2 on system level can be supported.

As mentioned above, certain embodiments of the present invention are related to aggregating overlapped carriers, for example in LTE-Advanced. This is described hereinafter in further detail.

That is, both Downlink and Uplink interference coordination for overlapped carriers can be of great advantage in future LTE releases, namely in the LTE-Advanced system. In 3GPP, it is widely agreed that an LTE Rel-8 backward compatible approach to providing more than 20 MHz bandwidth consists of aggregating 20 MHz and 10 MHz LTE Rel-8 carriers in an LTE-Advanced super channel structure.

In order to understand the benefits of the overlapped carrier concept for LTE-Advanced, an example of deploying 2×6 MHz carriers in a 12 MHz frequency block—which is typical in 2.6 GHz frequency bands—is studied in the following. Currently, there are basically three different methods for LTE-Advanced carrier aggregation discussed:

TABLE 2
Carrier aggregation in LTE-Advanced for
contiguous non-overlapping carriers

A)
Control channels in all
aggregated Component
Carriers (CC)
Each CC has its own
Transport Block
2 × 6 MHz (as extended
from 5 MHz)
2 × 5 MHz can be
allocated LTE Release 8
backward compatible
B)
Control channels in all
CCs
Single Transport Block
distributed over all
aggregated CCs
2 × 6 MHz (as extended
from 5 MHz)
2 × 5 MHz can be
allocated LTE Release 8
backward compatible
C)
Control channels only on
master CC
Single Transport Block
distributed over aggregated
master and slave CCs
10 MHz master bandwidth +
2 MHz slave bandwidth
10 MHz can be allocated
LTE Release 8 backward
compatible

While carrier aggregation in LTE-Advanced for non-overlapping carriers (see Table 2) requires bandwidth extension for LTE Release 8 backward compatibility on the one hand and standardization of RF requirements for new bandwidths (like 6 MHz in this example) on the other hand, using the overlapped aggregated carriers (see Table 3) enables LTE Release 8 backward compatibility directly. Also, the complete bandwidth is open for LTE Release 8 backward compatibility allowing for a higher amount of low-end mobiles also in an LTE-Advanced system.

That is, using the contiguous carrier aggregation concept for a 12 (2×6) MHz frequency block, the following possibilities exist:

TABLE 3
Carrier aggregation in LTE-Advanced for
contiguous overlapped carriers

A)
Control channels in all
aggregated Component
Carriers (CC)
Each CC has its own
Transport Block
10 MHz + overlapped 3 MHz
12 MHz can be allocated
LTE Release 8 backward
compatible
B)
Control channels in all
CCs
Single Transport Block
distributed over all
aggregated CCs
10 MHz + overlapped 3 MHz
12 MHz can be allocated
LTE Release 8 backward
compatible
C)
Control channels only on
master CC
Single Transport Block
distributed over aggregated
master and slave CCs
10 MHz master bandwidth +
2 MHz slave bandwidth
10 MHz can be allocated
LTE Release 8 backward
compatible

Certain embodiments of the present invention also include the following.

In an enhanced system such as e.g. the LTE-Advanced release of the 3GPP LTE standard selecting, combining, coordinating, and scheduling overlapping pre-configured channel bandwidths is applied to aggregated channels (or Component Carriers).

As aggregated channels (or Component Carriers) refer to a system enhancement where the user equipment uses these channels at the same time, these embodiments also comprise that the concept of overlapping carriers is applied to user equipment where overlapped pre-configured channel bandwidths are used at the same time.

As aggregated channels (or Component Carriers) also refer to a system where the base station performs scheduling decisions for various component carrier aggregation options, these embodiments also comprise that the base station can schedule in such a way that the user equipment can use overlapped pre-configured channel bandwidths at the same time. It is to be understood that a base station may also be a Node B and an evolved Node B, respectively.

According to the above description, it should be apparent that exemplary embodiments of the present invention provide, for example from the perspective of a base station such as an evolved Node B (eNB) or from the perspective of a user equipment, or a component thereof, an apparatus embodying the same, a method for controlling and/or operating the same, and computer program(s) controlling and/or operating the same as well as mediums carrying such computer program(s) and forming computer program product(s). The exemplary embodiments of the present invention particularly also include any combination of the above described features unless explicitly described to be technically contrary or exclusively alternative.

For example, described above are apparatuses, methods and computer program products capable of optimizing spectrum exploitation and network optimization e.g. by providing overlapped carriers.

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

What is described above is what is presently considered to be preferred embodiments of the present invention. However, as is apparent to the skilled reader, these are provided for illustrative purposes only and are in no way intended that the present invention is restricted thereto. Rather, it is the intention that all variations and modifications be included which fall within the spirit and scope of the appended claims.

1. An apparatus, comprising:
a carrier utilization element configured to utilize a combination of pre-configured channel bandwidths for wireless communication within an available frequency spectrum, wherein the combination includes overlapping pre-configured channel bandwidths.

2. The apparatus according to claim 1, wherein carriers corresponding to the overlapping pre-configured channel bandwidths comprise a time offset.

3. The apparatus according to claim 1, further comprising:
a downlink scheduler element configured to avoid allocation of a downlink data channel in a region of overlapping pre-configured channel bandwidths.

4. The apparatus according to claim 1, wherein outer guard bands for the available frequency spectrum in which no channels are to be allocated are provided by virtual guard bands of the pre-configured channel bandwidths.

5. The apparatus according to claim 3, wherein the downlink scheduler element is further configured to send cell-specific downlink reference symbols of both of the carriers corresponding to pair-wise overlapping pre-configured channel bandwidths in the region of overlapping pre-configured channel bandwidths.

6. The apparatus according claim 1, wherein the apparatus is configured as a user equipment component and wherein the carrier utilization element is further configured to utilize the overlapping pre-configured channel bandwidths at the same time.

7. The apparatus according to claim 1, wherein the apparatus is configured as a base station and wherein the carrier utilization element is further configured to schedule the overlapping pre-configured channel bandwidths for use at the same time.

8. A method, comprising:
utilizing a combination of pre-configured channel bandwidths for wireless communication by a carrier utilization element within an available frequency spectrum, wherein the combination includes overlapping pre-configured channel bandwidths.

9. The method according to claim 8, wherein carriers corresponding to the overlapping pre-configured channel bandwidths comprise a time offset.

10. The method according to claim 8, further comprising:
avoiding allocation of a downlink data channel in a region of overlapping pre-configured channel bandwidths by a downlink scheduler element.

11. The method according to claim 8, wherein outer guard bands for the available frequency spectrum in which no channels are to be allocated are provided by virtual guard bands of the pre-configured channel bandwidths.

12. The method according to claim 10, further comprising sending cell-specific downlink reference symbols of both of the carriers corresponding to pair-wise overlapping pre-configured channel bandwidths in the region of overlapping pre-configured channel bandwidths by the downlink scheduler element.

13. The method according claim 8, further comprising utilizing the overlapping pre-configured channel bandwidths at the same time by a user equipment component.

14. The method according to claim 8, further comprising scheduling the overlapping pre-configured channel bandwidths for use at the same time by a base station.

15. A computer program product embodied on a computer-readable medium encoded with instructions that, when executed on a computer, perform:
utilizing a combination of pre-configured channel bandwidths for wireless communication by a carrier utilization element within an available frequency spectrum, wherein the combination includes overlapping pre-configured channel bandwidths.

16. A system, comprising:
one or more power amplifier configured to provide at least two carrier having overlapping channel bandwidths; and
a cellular wireless communication network controller configured to provide an air interface communication protocol over a range covered by the overlapping channel bandwidth.

17. The system according to claim 16, further comprising:
a deployment element configured to deploy one of a set of combinations of pre-configured channel bandwidths, in which for each combination the carrier center frequency of each pre-configured channel bandwidth comprises the same distance to a lower edge of an available frequency spectrum, for a specific cell of the cellular network, and to deploy another one of the set of combinations for a cell neighboring to said specific cell.
